(19) United States
(12) Patent Application Publication
(10) Pub. No.: US 2010/0027295 A1
(43) Pub. Date: Feb. 4, 2010

(54) OPTICAL SHEET AND LIQUID CRYSTAL DISPLAY INCLUDING THE SAME

(76) Inventor: Chung Hyuk LEE, Chungju-si (KR)

Correspondence Address: BIRCH STEWART KOLASCH & BIRCH, PO BOX 747, FALLS CHURCH, VA, 22040-0747, US

(21) Appl. No.: 12/475,195

(22) Filed: May 29, 2009

(30) Foreign Application Priority Data
Jul. 29, 2008 (KR) 10-2008-0074181

(51) Int. Cl. F21V 7/04; G02B 5/02

(52) U.S. Cl. 362/622; 359/599

(57) ABSTRACT

An optical sheet and a liquid crystal display (LCD) including the same are provided. The optical sheet may include a base film; and a protrusion layer including a plurality of protrusions and disposed over the base film, wherein the base film includes a first layer over which the protrusion layer is disposed, and a second layer over which the first layer is disposed, wherein at least one of the first layer and the second layer includes a wavy surface where the first layer is disposed over the second layer. Therefore, it is possible to improve a haze of the optical sheet while maintaining an optical transmissivity of the optical sheet.

### CROSS-REFERENCE TO RELATED APPLICATION

This application claims the priority benefit of Korean Patent Application No. 10-2008-0074181, filed on Jul. 29, 2008 in the Korean Intellectual Property Office, the disclosure of which is incorporated herein by reference.

### BACKGROUND OF THE INVENTION

1. Field of the Invention

The present invention relates to an optical sheet and a liquid crystal display (LCD) including the same, and more particularly, to an optical sheet including a base film having first and second layers and an LCD including the optical sheet.

2. Description of the Related Art

Recently, types of displays capable of visually displaying information of various electric signals have rapidly increased. With this increase, various kinds of flat panel displays having excellent characteristics, such as having a thin profile, being light in weight, and having low power consumption, have been introduced. Accordingly, conventional cathode ray tubes (CRT) are being rapidly replaced by such flat panel displays. Examples of flat panel displays include a liquid crystal display (LCD), a plasma display panel (PDP), a field emission display (FED), and an electroluminescence display (ELD). LCDs have been widely used as display panels for laptop computers, monitors for personal computers (PCs), or as TV monitors because of their high contrast ratios and excellent moving picture-display characteristics.

LCDs, which are largely classified as light-receiving display devices, include an LCD panel displaying an image, and a backlight unit disposed below the LCD panel and providing the LCD panel with light. The backlight unit includes a light source and an optical sheet. The optical sheet typically includes a diffusion sheet, a prism sheet, and/or a protective sheet.

As uniformity of luminance of light provided to the LCD panel by the backlight unit decreases, the display quality of the LCD panel may gradually decrease. Even though the diffusion sheet is used to attempt to uniformly diffuse light over an entire surface of a display area of the LCD panel, and thus to reduce or prevent a reduction in the uniformity of the luminance of the LCD panel, it is still difficult for the diffusion sheet to properly secure both a high optical diffusivity, as well as a high luminance uniformity.

### SUMMARY OF THE INVENTION

Embodiments of the present invention provide an optical sheet which includes a base film having first and second layers, and can thus improve the uniformity of luminance and light diffusivity.

According to an aspect of the present invention, there is provided an optical sheet including a base film; and a protrusion layer including a plurality of protrusions and disposed over the base film, wherein the base film includes a first layer over which the protrusion layer is disposed, and a second layer over which the first layer is disposed, wherein at least one of the first layer and the second layer includes a wavy surface where the first layer is disposed over the second layer.

According to another aspect of the present invention, there is provided an apparatus including a light source; an optical sheet configured to receive light from the light source, the optical sheet including a base film; and a protrusion layer including a plurality of protrusions and disposed over the base film, wherein the base film includes a first layer over which the protrusion layer is disposed, a second layer over which the first layer is disposed, and the second layer is formed of the same material as that of the first layer, and the first layer and the second layer include a wavy surface where the first layer is disposed over the second layer.

### BRIEF DESCRIPTION OF THE DRAWINGS

The above and other features and advantages of the present invention will become more apparent by describing in detail example embodiments thereof with reference to the attached drawings in which:

FIGS. 1 through 3 illustrate diagrams of optical sheets according to example embodiments of the present invention;

FIG. 4 illustrates a perspective view of an optical sheet according to another example embodiment of the present invention;

FIGS. 5 and 6 illustrate diagrams of an optical sheet according to another example embodiment of the present invention;

FIGS. 7 through 10 illustrate perspective views of optical sheets according to other example embodiments of the present invention;

FIGS. 11 and 12 illustrate perspective views of optical sheets according to other example embodiments of the present invention; and

FIGS. 13 and 14 illustrate exploded perspective views of liquid crystal displays (LCDs) according to example embodiments of the present invention.

### DETAILED DESCRIPTION OF THE INVENTION

The present invention will hereinafter be described in detail with reference to the accompanying drawings in which example embodiments of the invention are shown.

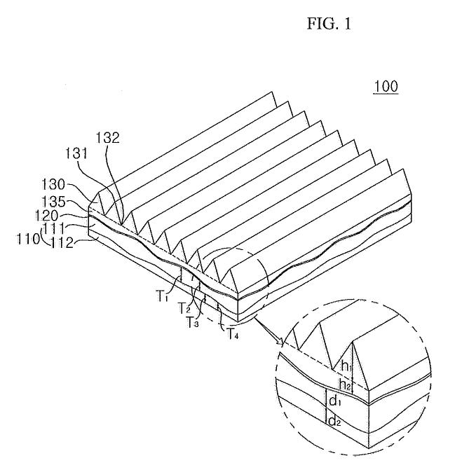

FIGS. 1 through 3 illustrate cross-sectional views of optical sheets according to example embodiments of the present invention. Referring to FIGS. 1 through 3, optical sheets 100, 100A, and 100B may each include a base film 110 and a protrusion layer 130 disposed on the base film 110. Hereinafter, disclosure regarding optical sheet 100 is also applicable to optical sheets 100A and 100B, for example.

The base film 110 may transmit light provided by a light source therethrough. For this, the base film 110 may be formed of a transparent material, and particularly, one of polyethylene terephthalate, polycarbonate, polypropylene, polyethylene, polystyrene, and polyepoxy. Embodiments of the present invention are not restricted to these materials.

The base film 110 may have a thickness of about 10-1000 μm, and particularly, 25-600 μm. In this case, the base film 110 may have excellent mechanical strength, excellent thermal stability, appropriate flexibility, and may reduce light loss. At least one surface of the base film 110 may be curved in a wavy shape (or may be wavy). The base film 110 may have a double-layer structure including a first layer 111 and a second layer 112.

At least one surface of each of the first and second layers 111 and 112 may be curved in, for example, a wavy shape so that a plurality of gentle peaks and a plurality of gentle valleys can be alternately formed thereon. In embodiments of the present invention, the least one surface of each of the first and second layers 111 and 112 may have undulating ridges and valleys. In other embodiments, the wavy surface may have sharp peaks and valleys.

The protrusion layer 130 may include a plurality of protrusions. The protrusions may be prisms as shown in FIGS. 1-3. In these cases, the protrusion layer 130 may have a plurality of peaks 131 and a plurality of valleys 132 of the prisms. The peaks 131 may have a uniform pitch. The height of the protrusions, such as the tip of the peaks 131, of the protrusion layer 130 may be uniform, but such is not required. The pitch of the peaks 131 and the height of the peaks 131 may be determined by the thickness and size of the base film 110, a desired luminance uniformity level, and a desired optical diffusivity of the optical sheets.

The base film 110 may be formed through coextrusion to have the first and second layers 111 and 112. The base film 110 having been formed through coextrusion may be formed such that each of the first and second layers 111 and 112 can have at least one curved surface. By using coextrusion, it is possible to quickly form a base film 110 having a number of thin layers properly distributed therein with precision. Accordingly, in various embodiments of the present invention, the base film 110 is not limited to having just two coextruded layers, but rather, may have more than the noted two layers.

In order to keep up with a recent trend in the manufacture of backlight units, i.e., the reduction of the thickness of backlight units, the base film 110 may be formed to a thickness of about 10-1000 μm, and particularly, 25-600 μm. More specifically, the base film 110 may be formed to a thickness of 25 μm or more in order to minimize the thickness of a backlight unit without compromising the mechanical properties and thermal resistance of the optical sheet 100. In addition, the base film 110 may be formed to a thickness of 600 μm or less in order to improve the mechanical properties and thermal resistance of the optical sheet 100 while not contributing to the reduction of the thickness of a backlight. The ratio of a thickness d1 of the first layer 111 to a thickness d2 of the second layer 112 at one point on the base film 110 may be about 1:1 to 49:1. At least one surface of each of the first and second layers 111 and 112 may be curved in a wavy shape. In various embodiments of the present invention, at least one of the first layer 111 and the second layer 112 may include the wavy surface where the first layer 111 is disposed over the second layer 112.

Since the first layer 111 of the base film 110 has at least one curved surface, a first thickness T₁ of the first layer 111 at one point on the base layer 110 may be different from a second thickness T₂ of the first layer 111 at another point on the base layer 110. The first and second thicknesses T₁ and T₂ of the base layer 110 may satisfy the following equation: 0.1 μm≦|T₁−T₂|≦10 μm.

Table 1 shows the relationship between the difference between the first and second thicknesses T₁ and T₂ (i.e., |T₁−T₂ |) and the diffusion effect and luminance of the optical sheet 100. In Table 1, X, ◯, and ⊚ represent bad, good, and excellent states of the characteristics, respectively.

TABLE 1

| \|T₁ − T₂\| (μm) | Diffusion Effect | Luminance |
|---|---|---|
| 0.05 | X | ⊚ |
| 0.1 | ◯ | ⊚ |
| 1 | ◯ | ⊚ |
| 3 | ◯ | ◯ |
| 5 | ◯ | ◯ |
| 7 | ◯ | ◯ |
| 9 | ⊚ | ◯ |
| 10 | ⊚ | ◯ |
| 15 | ⊚ | X |

Referring to Table 1, if the first and second distances T₁ and T₂ satisfy the following equation: 0.1 μm≦|T₁−T₂|, the first layer 111 may be able to effectively diffuse light incident thereupon from a light source because of its non-flat surfaces. If the first and second distances T₁ and T₂ satisfy the following equation: |T₁−T₂|≦10 μm, the first layer 111 may be able to reduce or prevent the luminance of the optical sheet 100 from decreasing due to such large thickness difference of the first layer 111.

The second layer 112, like the first layer 111, may have at least one curved surface. More specifically, at least one surface of the second layer 112 may be curved in a wavy shape (or have a wavy surface). A third thickness T₃ of the second layer 112 at one point on the base film 110 may be different from a fourth thickness T₄ of the second layer 112 at another point on the base film 110.

The third and fourth thicknesses T₃ and T₄ may satisfy the following equation: 0.1 μm≦|T₃−T₄|≦10 μm. The influence of the difference between the third and fourth thicknesses T₃ and T₄ (i.e., |T₃−T₄|) on the diffusion effect and luminance of the optical sheet 100 is the same as the influence of the difference between the first and second thicknesses T₁ and T₂ (i.e., |T₁−T₂|) on the diffusion effect and luminance of the optical sheet 100, and thus, a detailed description thereof will be omitted.

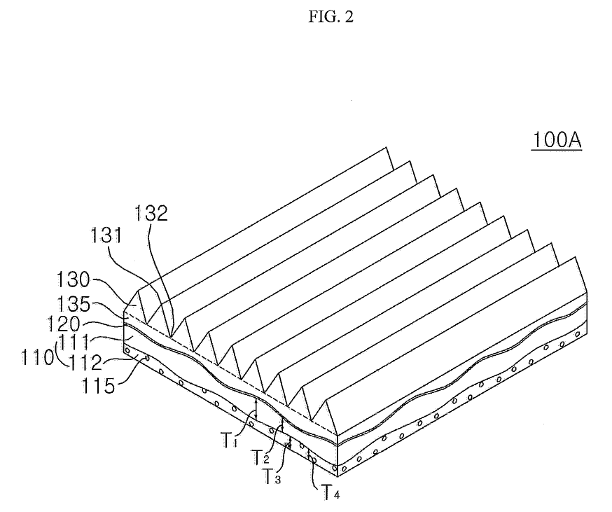

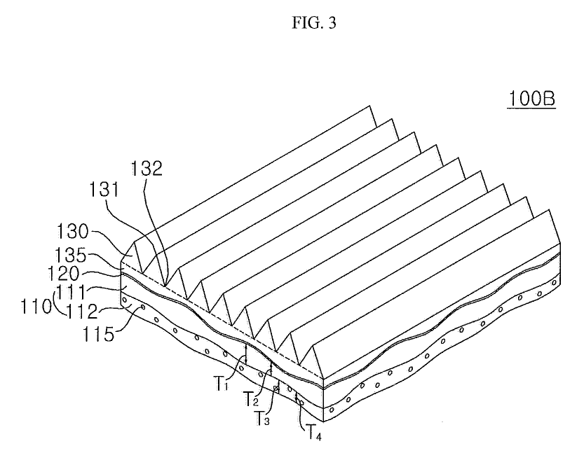

Referring to FIGS. 2 and 3, the second layer 112 may include particles 115. The particles 115 may be formed of, or include, at least one of polymethylmethacrylate (PMMA), polystyrene, and silicon. The particles 115 may be provided in an amount of approximately 10 to 30 parts by weight based on 100 parts by weight of the second layer 112. If the particles 115 are provided in an amount of less than 10 parts by weight based on 100 parts by weight of the second layer 112, the second layer 112 may not be able to properly diffuse light incident thereupon from a light source.

On the other hand, if the particles 115 are provided in an amount of more than 30 parts by weight based on 100 parts by weight of the second layer 112, the particles 115 may reduce or block the transmission of light through the second layer 112. In embodiments of the present invention, the particles 115 need not have the same diameters. The particles 115 may be uniformly or non-uniformly distributed in the second layer 112, or both distributions may be present. The particles 115 may be completely buried in the second layer 112 instead of being exposed on the second layer 112, though such is not required. Accordingly, some of the particles 115 may be buried and some may be exposed.

If the particles 115 are provided in an amount of 10-30 parts by weight based on 100 parts by weight of the second layer 112, a haze of the base film 110 may be 7-40%. If the haze of the base film 110 is lower than 7%, the base film 110 may not be able to provide sufficient viewing angles for a liquid crystal display (LCD). On the other hand, if the haze of the base film 110 is higher than 40%, the base film 110 may reduce the luminance of the liquid crystal display (LCD).

In short, the particles 115 are provided in an amount of 10-30 parts by weight based on 100 parts by weight of the second layer 112. As a result, the base film 110 may be able to properly focus and diffuse light. Thus, it is possible to increase the haze of the base film 110 and maintain the optical transmissivity of the optical sheet 100.

The second layer 112 is illustrated in FIG. 2 as including the particles 115, but the embodiments of the present invention are not restricted to this. That is, referring to FIG. 1, the second layer 112 need not include any particles. In addition, the first layer 111 of the base film 110 is illustrated in FIG. 1 as having curved top and bottom surfaces, but the present invention is not restricted to this. That is, referring to FIG. 3, the second layer 112 may also have curved top and bottom surfaces.

In short, the following example embodiments of the present invention can be applied not only to an optical sheet including a base film having a first layer with curved top and bottom surfaces but also to an optical sheet including a base film having a second layer with a curved bottom surface.

Referring to FIGS. 1 through 3, the optical sheets 100, 100A, and 100B may further include a first primer layer 120 disposed between the base film 110 and the protrusion layer 130. The first primer layer 120 may be formed through a priming operation. The priming operation involves treating a polymer film using a polymer material, and can thus enhance the adhesiveness of the polymer film to ultraviolet (UV) resin.

Examples of the polymer material used in the priming operation include acryl, ester and urethane. More specifically, an aqueous polymer material may be used in the priming operation in order to reduce a probability of a fire hazard. More specifically, the first primer layer 120 may be formed through the priming operation by applying a polymer material onto the base film 110 and coating the base film 110 with the polymer material using a coater.

The first primer layer 120 may be formed to a thickness of 5-300 nm. If the thickness of the first primer layer 120 is less than 5 nm, the first primer layer 120 may not be able to have sufficient adhesiveness. On the other hand, if the thickness of the first primer layer 120 is greater than 300 nm, various problems such as the generation of smudges and the coagulation of a polymer material may occur during the priming operation.

The protrusion layer 130 may focus light incident thereupon from a light source and may include a plurality of prisms, as shown, for example. In order to properly transmit light, the protrusion layer 130 may be formed of a transparent polymer resin. For example, the protrusion layer 130 may be formed of one of acryl, polycarbonate, polypropylene, polyethylene, and polyethylene terephthalate, for example, or other materials.

The protrusion layer 130 may include a plurality of prisms having a triangular cross-section. The protrusions of the protrusion layer 130 may be linearly formed along a longitudinal direction of the protrusion layer 130. The protrusions of the protrusion layer 130 may be formed as prisms, but the present invention is not restricted to this. The protrusion layer 130 may have the peaks 131 and the valleys 132. The optical sheet 100 may also include a base portion 135 disposed below the protrusion layer 130. The base portion 135 may be formed integrally in one body with the protrusion layer 130.

The base portion 135 may connect the base film 110 and the protrusion layer 130. Due to the base portion 135, it is possible to easily form the protrusion layer 130. A thickness h₂ of the base portion 135 may be defined as being the same as the distance between the protrusion layer 130 and the first primer layer 120. The thickness h₂ may be 5-50% of a height h₁ of the peaks 131. If the thickness h₂ is less than 5% of the height h₁, the base film 110 may be damaged during the formation of the protrusion layer 130. On the other hand, if the thickness h₂ is greater than 5% of the height h₁, the base 135 may become too thick to properly transmit light therethrough, and thus, the optical transmissivity of the optical sheet 100 may decrease.

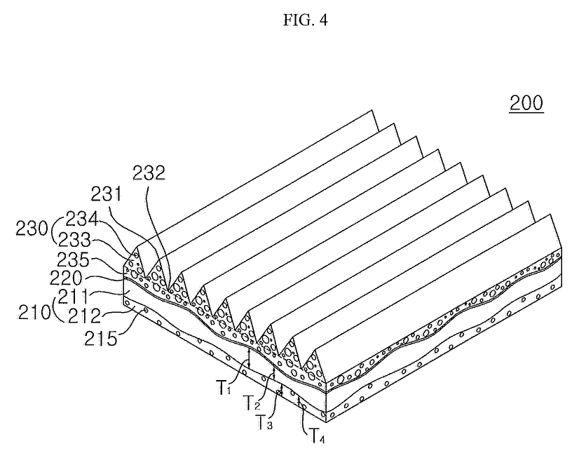

FIG. 4 illustrates a perspective view of an optical sheet 200 according to another example embodiment of the present invention. Referring to FIG. 4, the optical sheet 200 may include a base film 210, a first primer layer 220 disposed on the base film 210, and a protrusion layer 230 disposed on the first primer layer 220. The protrusion layer 230 may include a first resin 233 and a plurality of first beads 234 distributed in the first resin 233.

The base film 210 may include first and second layers 211 and 212. The first and second layers 211 and 212 may be formed through coextrusion. A first thickness T₁ of the first layer 211 at one point on the base film 210 may be different from a second thickness T₂ of the first layer 211 at another point on the base film 210. Likewise, a third thickness T₃ of the second layer 212 at one point on the base film 210 may be different from a fourth thickness T₄ of the second layer 212 at another point on the base film 210. The second layer 212 may contain particles 215. The base film 210 and the first primer layer 220 are essentially the same as the base film 110 and the first primer layer 120 of the example embodiment of FIGS. 1 through 3, and thus, detailed descriptions thereof will be omitted.

The protrusion layer 230 may include a base portion 235, the first resin 233 and the first beads 234. The base portion 235 is essentially the same as the base portion 135 of the example embodiment of FIGS. 1 through 3, and thus, a detailed description thereof will be omitted. The first resin 233 may be formed of acrylic resin. Examples of the first resin 233 include unsaturated polyester, methyl methacrylate, ethyl methacrylate, isobutyl methacrylate, normal butyl methyl methacrylate, acrylic acid, methacrylic acid, hydroxyethyl methacrylate, hydroxypropyl methacrylate, hydroxyethyl acrylate, acrylamide, methylol acrylamide, glycidyl methacrylate, ethyl acrylate, isobutyl acrylate, normal butyl acrylate, an acrylic-based material such as 2-ethylhexyl acrylate polymer, 2-ethylhexyl acrylate copolymer or 2-ethylhexyl acrylate terpolymer, a urethane-based material, an epoxy-based material, a melamine-based material, polycarbonate, and polystyrene, as well as other materials.

The first beads 234 may diffuse and transmit light incident thereupon from a light source. For this, the first beads 234 may be formed of an organic or inorganic material with high optical transmissivity and high optical diffusivity. For examples, the first beads 234 may be formed of methyl methacrylate, ethyl methacrylate, isobutyl methacrylate, normal butyl methacrylate, normal butyl methyl methacrylate, acrylic acid, methacrylic acid, hydroxyethyl methacrylate, hydroxypropyl methacrylate, hydroxyethyl acrylate, acrylamide, methylol acrylamide, glycidyl methacrylate, ethyl acrylate, isobutyl acrylate, normal butyl acrylate, an acrylic-based material (such as 2-ethylhexyl acrylate polymer, 2-ethylhexyl acrylate copolymer or 2-ethylhexyl acrylate terpolymer), an olefin-based material such as polyethylene, polystyrene, and polypropylene, a copolymer of acryl and an acrylic-olefin copolymer, or an organic material such as a multilayer multi-component material obtained by covering a homopolymer with a monomer, as well as other materials.

The first beads 234 may be provided in an amount of 1-10 parts by weight based on 100 parts by weight of the first resin 233. If the first beads 234 are provided in an amount of less than 1 part by weight based on 100 parts by weight of the first resin 233, the protrusion layer 230 may not be able to properly diffuse light incident thereupon from a light source. On the other hand, if the first beads 234 are provided in an amount of more than 10 parts by weight based on 100 parts by weight of the first resin 233, the optical transmissivity of the protrusion layer 230 may decrease.

The first beads 234 need not have the same diameter. The first beads 234 may be uniformly or non-uniformly distributed in the first resin 233, or both distributions may be present. The first beads 234 may all be buried in the first resin 233, instead of being exposed on the surface of the first resin 233. Accordingly, some of the beads 234 may be buried and some may be exposed.

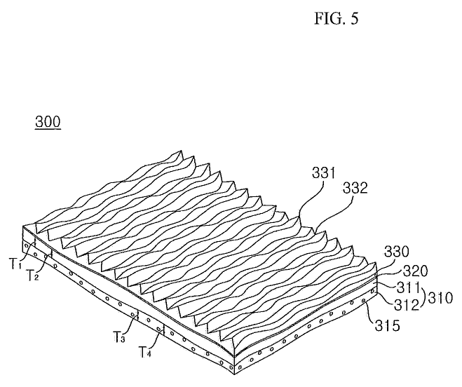

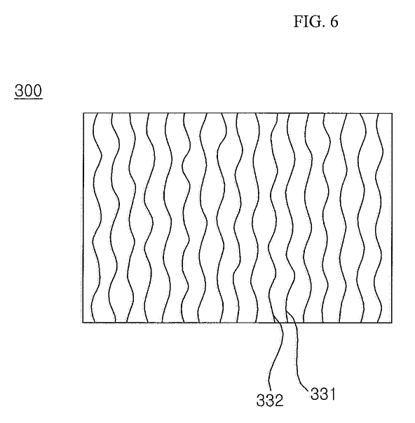

FIGS. 5 and 6 illustrate a perspective view and a top view, respectively, of an optical sheet 300 according to another example embodiment of the present invention. Referring to FIGS. 5 and 6, the optical sheet 300 may include a base film 310, a first primer layer 320 disposed on the base film 310, and a protrusion layer 330 disposed on the first primer layer 320. The protrusion layer 330 may include a plurality of protrusions and may have a plurality of peaks 331 and a plurality of valleys 332. The protrusions may be prisms, or other shapes.

The base film 310 may include first and second layers 311 and 312. The first and second layers 311 and 312 may be formed through coextrusion. A first thickness T₁ of the first layer 311 at one point on the base film 310 may be different from a second thickness T₂ of the first layer 311 at another point on the base film 310. Likewise, a third thickness T₃ of the second layer 312 at one point on the base film 310 may be different from a fourth thickness T₄ of the second layer 312 at another point on the base film 310.

The second layer 312 may contain particles 315. The base film 310 and the first primer layer 320 are essentially the same as the base film 110 and the first primer layer 120 of the example embodiment of FIGS. 1 through 3, and thus, detailed descriptions thereof will be omitted. The protrusion layer 330 may include a plurality of prisms with a triangular cross-section. The prisms may have a pitch of 20-300 μm.

In the embodiment shown in FIG. 5, the protrusions of the protrusion layer 330 may wind (or weave) along a longitudinal direction of the protrusion layer 330. The protrusions of the protrusion layer 330 may have an average horizontal amplitude of 1-20 μm.

The height of the peaks 331 may randomly or periodically vary along the longitudinal direction of the protrusion layer 330. For example, the height of the peaks 331 may have an average deviation of 1-20 μm. Likewise, the height of the valleys 332 may randomly or periodically vary (wind or weave) along the longitudinal direction of the protrusion layer 330.

Therefore, even though the peaks 331 of the protrusion layer 330 may be worn away by physically contacting other sheets, such abrasions of the protrusion layer 330 may not be easily detected visibly and may thus be restricted or prevented from adversely affecting the picture quality of an LCD.

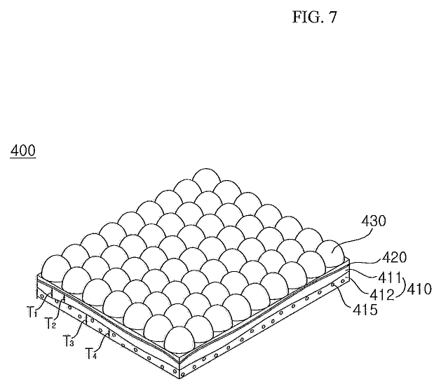

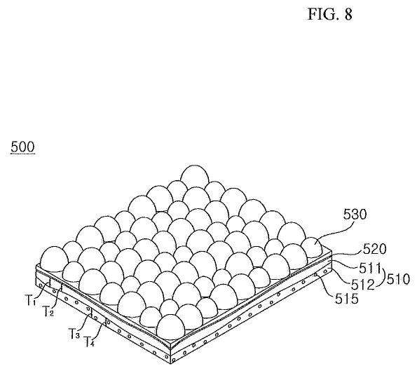

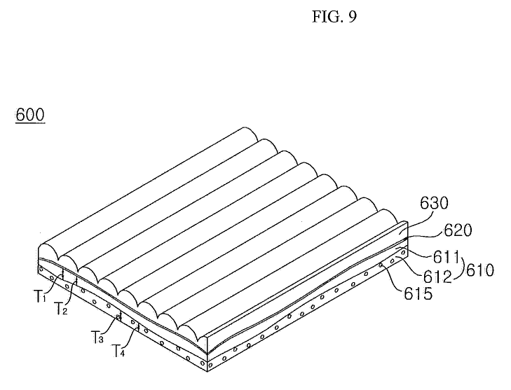

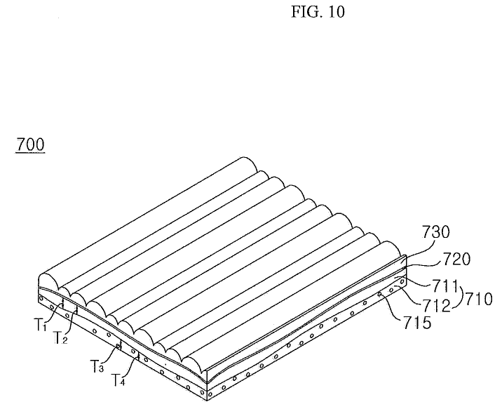

FIGS. 7, 8, 9 and 10 illustrate perspective views of optical sheets 400, 500, 600, and 700, respectively, according to other example embodiments of the present invention. Referring to FIGS. 7 and 8, the optical sheets 400 and 500 may each include a micro-lens array (MLA). Referring to FIGS. 9 and 10, the optical sheets 600 and 700 may each include a plurality of lenticular lenses.

With reference to FIG. 7, the optical sheet 400 may include a base film 410, a first primer layer 420 disposed on the base film 410, and a protrusion layer 430 disposed on the first primer layer 420. The protrusion layer 430 may include a plurality of protrusions. The protrusions may be the MLA.

The base film 410 may include first and second layers 411 and 412. The first and second layers 411 and 412 may be formed through coextrusion. A first thickness T₁ of the first layer 411 at one point on the base film 410 may be different from a second thickness T₂ of the first layer 411 at another point on the base film 410. Likewise, a third thickness T₃ of the second layer 412 at one point on the base film 410 may be different from a fourth thickness T₄ of the second layer 412 at another point on the base film 410. The second layer 412 may contain particles 415.

The base film 410 and the first primer layer 420 are essentially the same as the base film 110 and the first primer layer 120 of the example embodiment of FIGS. 1 through 3, and thus, detailed descriptions thereof will be omitted.

The protrusion layer 430 may include an MLA which can focus light incident thereupon from a light source. The MLA of the protrusion layer 430 may include an array of a plurality of hemispherical protrusions. The protrusions of the protrusion layer 430 may have the same size. The protrusions of the protrusion layer 430 may be formed in various shapes other than a hemispherical shape, such as pyramidal or cubical shape.

Referring to FIG. 8, the optical sheet 500 may include a base film 510, a first primer layer 520 disposed on the base film 510, and a protrusion layer 530 disposed on the first primer layer 520. The protrusion layer 530 may include a plurality of protrusions. The protrusions may be an MLA.

The base film 510 may include first and second layers 511 and 512. The first and second layers 511 and 512 may be formed through coextrusion. A first thickness T₁ of the first layer 511 at one point on the base film 510 may be different from a second thickness T₂ of the first layer 511 at another point on the base film 510. Likewise, a third thickness T₃ of the second layer 512 at one point on the base film 510 may be different from a fourth thickness T₄ of the second layer 512 at another point on the base film 510. The second layer 512 may contain particles 515.

The base film 510 and the first primer layer 520 are essentially the same as the base film 110 and the first primer layer 120 of the example embodiment of FIGS. 1 through 3, and thus, detailed descriptions thereof will be omitted. The protrusion layer 530 may include an MLA. The MLA of the protrusion layer 530 may include an array of a plurality of hemispherical protrusions.

In the example embodiment of FIG. 8, unlike in the example embodiment of FIG. 7, the protrusions of the protrusion layer 530 may have different sizes. The protrusions of the protrusion layer 530 may be formed in various shapes other than a hemispherical shape, such as pyramidal or cubical shape.

In short, the protrusion layer 530 includes an array of micro-lenses having different sizes. Thus, even though the peaks of the protrusions of the protrusion layer 530 may be worn away by physically contacting other sheets, such abrasions of the protrusion layer 530 may not be easily detected visibly and may thus be restricted or prevented from adversely affecting the picture quality of an LCD. In embodiments of the present invention, the placement of different sized micro-lenses as the protrusions of the protrusion layer 530 may be periodic, random, or a combination thereof.

Referring to FIG. 9, the optical sheet 600 may include a base film 610, a first primer layer 620 disposed on the base film 610, and a protrusion layer 630 disposed on the first primer layer 620. The protrusion layer 630 may include a plurality of protrusions. The protrusions may be lenticular lenses.

The base film 610 may include first and second layers 611 and 612. The first and second layers 611 and 612 may be formed through coextrusion. A first thickness T₁ of the first layer 611 at one point on the base film 610 may be different from a second thickness T₂ of the first layer 611 at another point on the base film 610. Likewise, a third thickness T₃ of the second layer 612 at one point on the base film 610 may be different from a fourth thickness T₄ of the second layer 612 at another point on the base film 610. The second layer 612 may contain particles 615.

The base film 610 and the first primer layer 620 are essentially the same as the base film 110 and the first primer layer 120 of the example embodiment of FIGS. 1 through 3, and thus, detailed descriptions thereof will be omitted.

The protrusion layer 630 may include a plurality of lenticular lenses having a semicircular cross-section. The lenticular lenses may be arranged in parallel with one side of the base film 610. The lenticular lenses of the protrusion layer 630 may focus light incident thereupon from a light source.

Referring to FIG. 10, the optical sheet 700 may include a base film 710, a first primer layer 720 disposed on the base film 710, and a protrusion layer 730 disposed on the first primer layer 720. The protrusion layer 730 may include a plurality of protrusions. The protrusions may be lenticular lenses.

The base film 710 may include first and second layers 711 and 712. The first and second layers 711 and 712 may be formed through coextrusion. A first thickness T₁ of the first layer 711 at one point on the base film 710 may be different from a second thickness T₂ of the first layer 711 at another point on the base film 710. Likewise, a third thickness T₃ of the second layer 712 at one point on the base film 710 may be different from a fourth thickness T₄ of the second layer 712 at another point on the base film 710. The second layer 712 may contain particles 715.

The base film 710 and the first primer layer 720 are essentially the same as the base film 110 and the first primer layer 120 of the example embodiment of FIGS. 1 through 3, and thus, detailed descriptions thereof will be omitted. The protrusion layer 710 may include a plurality of lenticular lenses. In the example embodiment of FIG. 10, unlike in the example embodiment of FIG. 9, the pitch of the lenticular lenses of the protrusion layer 710 may not be uniform.

In short, the protrusion layer 730 includes an array of lenticular lenses having different pitches. Thus, even though the peaks of the protrusions of the protrusion layer 730 may be worn away by physically contacting other sheets, such abrasions of the protrusion layer 730 may not be easily detected visibly and may thus be restricted or prevented from adversely affecting the picture quality of an LCD. In embodiments of the present invention, the lenticular lenses may have different sizes, and placement of different sized lenticular lenses as the protrusions of the protrusion layer 710 may be periodic, random, or a combination thereof.

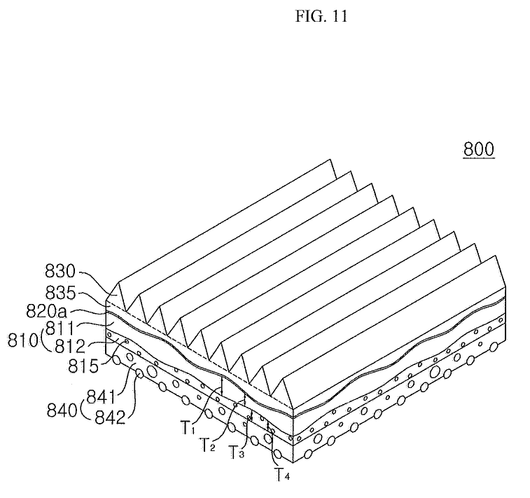

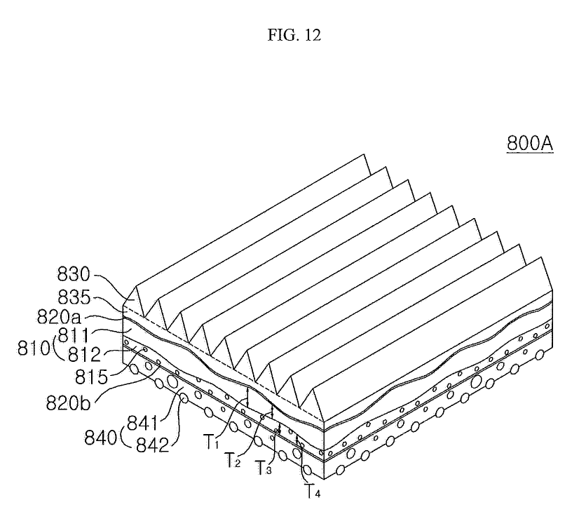

FIGS. 11 and 12 illustrate perspective views of optical sheets according to other example embodiments of the present invention. Referring to FIG. 11, the optical sheet 800 may include a base film 810, a first primer layer 820a disposed on the base film 810, and a protrusion layer 830 disposed on the first primer layer 820a. The optical sheet 800 may also include a protective layer 840 disposed below the base film 810.

The base film 810 may include first and second layers 811 and 812. The first and second layers 811 and 812 may be formed through coextrusion. A first thickness T₁ of the first layer 811 at one point on the base film 810 may be different from a second thickness T₂ of the first layer 811 at another point on the base film 810. Likewise, a third thickness T₃ of the second layer 812 at one point on the base film 810 may be different from a fourth thickness T₄ of the second layer 812 at another point on the base film 810. The second layer 812 may contain particles 815.

The base film 810 and the first primer layer 820 are essentially the same as the base film 110 and the first primer layer 120 of the example embodiment of FIGS. 1 through 3, and thus, detailed descriptions thereof will be omitted.

The protective layer 840 may include a second resin 841 and a plurality of second beads distributed in the second resin 841. The second resin 841 may be formed of a transparent material having excellent thermal resistance and excellent mechanical properties. For example, the second resin 841 may be formed of acrylic resin such as polyarylate or PMMA.

The second beads 842 may be formed of the same material as or a different material from the second resin 841. The second beads 842 may be provided in an amount of 10-50 parts by weight based on 100 parts by weight of the second resin 841. The diameter of the second beads 842 may be determined based on the thickness of the base film 810. For example, the second beads 842 may have a diameter of about 2-10 μm. The second beads 842 may have the same diameter and may be uniformly distributed in the second resin 841.

Alternatively, the second beads 842 may have different diameters and may be non-uniformly distributed in the second resin 841. Some of the second beads 842 may be exposed on the second resin 841. The second beads 842 may be formed of the same material as or a different material from the first beads 234 of FIG. 4.

The protective layer 840 may reduce or prevent the optical sheet 800 from being deformed due to heat generated by a light source. That is, since the second resin 841 is robust against heat, it is possible to reduce or prevent the optical sheet 800 from being wrinkled (or buckled) due to heat. Even if the optical sheet 800 is deformed at high temperature, the optical sheet 800 can be easily restored to its original state due to the protective layer 840. The protective layer 840 may reduce or prevent the optical sheet 800 from being damaged by external shock or other physical forces.

Alternatively, referring to FIG. 12, the optical sheet 800A may include a second primer layer 820b disposed below the base film 810 and a protective layer 840 disposed below the second primer layer 820b. The second primer layer 820b may be the same as the first primer layer 820a shown in FIG. 11. The second primer layer 820 may improve the adhesion between the base film 810 and the protective layer 840.

As described above, the protective layer 840 may reduce or prevent the optical sheet 800 from being deformed due to heat generated by a light source. That is, since the second resin 841 is robust against heat, it is possible to reduce or prevent the optical sheet 800 from being wrinkled (buckled) due to heat. Even if the optical sheet 800 is deformed at high temperature, the optical sheet 800 can be easily restored to its original state due to the protective layer 840.

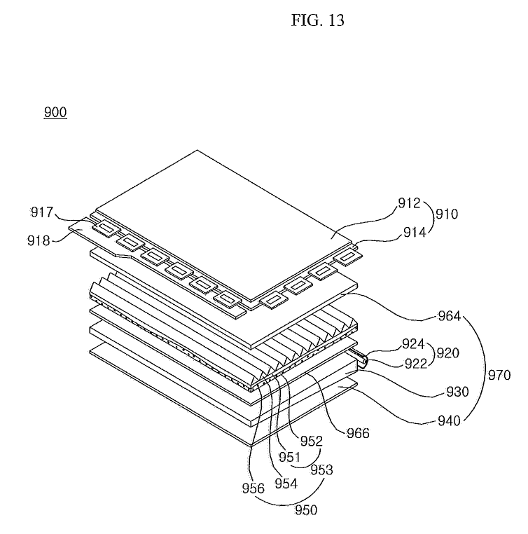

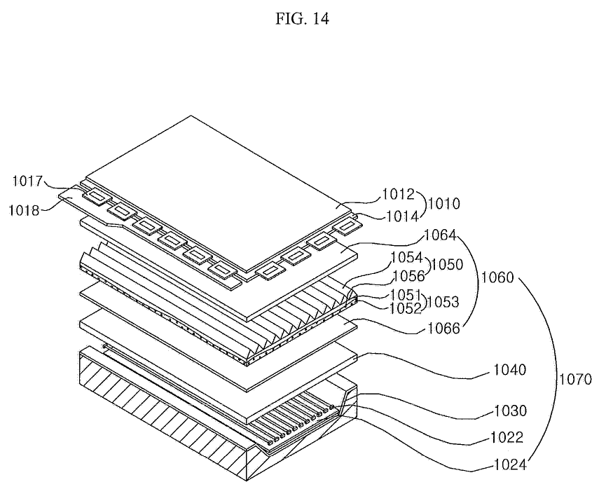

FIGS. 13 and 14 illustrate exploded perspective views of LCDs 900 and 1000, respectively, according to example embodiments of the present invention. Referring to FIG. 13, the LCD 900 may include an edge-type backlight unit. More specifically, the LCD 900 may include an LCD panel 910 and a backlight unit 970 providing light to the LCD panel 910.

The LCD panel 910 may display an image using light provided by the backlight unit 970. The LCD panel 910 may include a color filter substrate 912 and a thin film transistor (TFT) substrate 914. The color filter substrate 912 and the TFT substrate 914 may face each other, and liquid crystal molecules may be interposed between the color filter substrate 912 and the TFT substrate 914. The color filter substrate 912 may realize various colors for an image displayed on the LCD panel 910.

The TFT substrate 914 may be electrically connected through a drive film 917 to a printed circuit board (PCB) 918 having a plurality of circuit parts mounted thereon. The TFT substrate 914 may apply a drive voltage provided by the PCB 918 to the liquid crystal molecules in response to a drive signal provided by the PCB 918. The TFT substrate 914 may include a substrate formed of a transparent material such as glass or plastic, and a plurality of TFTs and a plurality of pixel electrodes formed on the substrate.

The backlight unit 970 may include a light source 920 which emits light, a light guide plate 930 which transforms the light emitted by the light source 920 into surface light and provides the surface light to the LCD panel 910, an optical film which uniformly distributes the light provided by the light guide plate 930 and thus improves the vertical incidence of the light, and a reflective sheet 940 which reflects light emitted from the bottom of the light guide plate 930 back toward the light guide plate 930.

The light source 920 may include a lamp 922 disposed on one side of the light guide plate 930 and a reflective plate 924 reflecting light emitted from the lamp 922 toward the light guide plate 930. The lamp 922 may be a cold cathode fluorescent lamp (CCFL), an external electrode fluorescent lamp (EEFL), a light emitting diode (LED) or a flat fluorescent lamp (FFL), but the embodiments of the present invention are not limited to this.

The optical film may include a diffusion sheet 966 diffusing light incident thereupon from the light guide plate 930 toward the LCD panel 910 and an optical sheet 950 focusing light diffused by the diffusion sheet 966, and thus improving the vertical incidence of the light. The optical film may also include a protective sheet 964 protecting the optical sheet 950. The optical sheet 950 may include a base film 953 and a protrusion layer 954 disposed on the base film 953.

The base film 953 may include first and second layers 951 and 952. The first and second layers 951 and 952 may be formed through coextrusion. The thickness of the first layer 951 may vary from one point to another point on the base film 953. Likewise, the thickness of the second layer 952 may vary from one point to another point on the base film 953. The second layer 952 may contain particles 956. Thus, it is possible to increase the haze of the base film 953 while appropriately maintaining the optical transmissivity of the optical sheet 950.

The structure of the backlight unit 970 is not restricted to that set forth herein. That is, the various embodiments of the present invention can be applied not only to an LCD including an edge-type backlight unit but also to an LCD including a direct-type backlight unit.

Referring to FIG. 14, the LCD 1000 may include a direct-type backlight unit. More specifically, the LCD 1000 may include an LCD panel 1010 and a backlight unit 1070 providing light to the LCD panel 1010. The LCD panel 1010 is similar to the LCD panel 910 shown in FIG. 13, and thus, a detailed description thereof will be omitted.

The backlight unit 1070 may include a plurality of light sources 1022, a reflective sheet 1024, a lower chassis 1030 accommodating the light sources 1022 and the reflective sheet 1024 therein, a diffusion plate 1040 disposed above the light sources 1022, and an optical film 1060. The light sources 1022 may be line light sources such as CCFLs or EEFLs or may be LEDs, but the present invention is not restricted to this.

The reflective sheet 1024 may reflect light emitted from the light sources 1022 toward the LCD panel 1010 and may thus improve the efficiency of use of the light. The light emitted from the light sources 1022 may be incident upon the diffusion plate 1040. The optical film 1060 may be disposed on the diffusion plate 1040. The optical film 1060 may include a diffusion sheet 1066, an optical sheet 1050 and a protective sheet 1064.

The optical sheet 1050 may include a base film 1053 and a protrusion layer 1054 disposed on the base film 1053. The base film 1053 may include first and second layers 1051 and 1052. The first and second layers 1051 and 1052 may be formed through coextrusion. The thickness of the first layer 1051 may vary from one point to another point on the base film 1053. Likewise, the thickness of the second layer 1052 may vary from one point to another point on the base film 1053. The second layer 1052 may contain particles 1056. Thus, it is possible to increase the haze of the base film 1053 while appropriately maintaining the optical transmissivity of the optical sheet 1050.

In embodiments of the present invention, when a layer is on another layer, such also refers to the layer being over the another layer. Also, when the layer or element is referred to as being “on” or “over” another layer, it can be directly on the other layer, or intervening layers may also be present. Further, it will be understood that when a layer is referred to as being “under” or “below” another layer, it can be directly under, or one or more intervening layers may also be present.

In embodiments of the present invention, discussions relating to particles are also applicable to beads, and vice versa. Also, the particles and beads need not be limited to a particular size or a particular shape. Accordingly, the particles and/or beads may be spherical, cubical, cylindrical, or other shapes.

In embodiments of the present invention, haze may include translucence. Additionally, the base film may be formed by coextruding more than two layers.

While the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. An optical sheet comprising:
a base film; and
a protrusion layer including a plurality of protrusions and disposed over the base film,
wherein the base film includes a first layer over which the protrusion layer is disposed, and a second layer over which the first layer is disposed, and
wherein at least one of the first layer and the second layer includes a wavy surface where the first layer is disposed over the second layer.

2. The optical sheet of claim 1, wherein the first layer has a first thickness T1 at one point on the base film and a second thickness T2 at another point on the base film, and the first and second thicknesses T1 and T2 are different from each other.

3. The optical sheet of claim 2, wherein the first and second thicknesses T1 and T2 satisfy the following equation: 0.1 μm≦|T1−T2|≦10 μm.

4. The optical sheet of claim 1, wherein the second layer has a third thickness T3 at one point on the base film and a fourth thickness T4 at another point on the base film, and the third and fourth thicknesses T3 and T4 are different from each other.

5. The optical sheet of claim 4, wherein the third and fourth thicknesses T3 and T4 satisfy the following equation: 0.1 μm≦|T3−T4|≦10 μm.

6. The optical sheet of claim 1, wherein a ratio between thicknesses of the first and second layers at one point of the base film ranges from approximately 1:1 to 49:1.

7. The optical sheet of claim 1, wherein the first and second layers are formed through coextrusion.

8. The optical sheet of claim 1, wherein the second layer includes particles, which are provided in an amount of approximately 10 to 30 parts by weight based on 100 parts by weight of the second layer.

9. The optical sheet of claim 1, further comprising a first primer layer disposed between the first layer and the protrusion layer, wherein a thickness of the first primer layer ranges from approximately 5 nm to 300 nm.

10. The optical sheet of claim 1, further comprising a second primer layer on which the second layer is disposed, wherein a thickness of the second primer layer is approximately 5 nm to 300 nm.

11. The optical sheet of claim 1, wherein the protrusion layer includes a first resin, and a plurality of first beads provided in an amount of approximately 1 to 10 parts by weight based on 100 parts by weight of the first resin.

12. The optical sheet of claim 1, further comprising a protective layer over which the base film is disposed,
wherein the protective layer includes a second resin and a plurality of second beads either exposed on a surface of the second resin or buried in the second resin.

13. The optical sheet of claim 1, wherein the plurality of protrusions include at least one of prisms, a micro-lens array (MLA), and lenticular lenses.

14. The optical sheet of claim 13, wherein the plurality of protrusions include the prisms, the prisms form a plurality of peaks and a plurality of valleys, and pitches of the peaks vary along a longitudinal direction of the plurality of protrusions.

15. The optical sheet of claim 1, wherein the protrusion layer includes a base portion, and the plurality of protrusions extend from the base portion.

16. The optical sheet of claim 15, wherein a height of the base portion is approximately 5% to 50% of a height of one of the plurality of protrusions.

17. The optical sheet of claim 13, wherein the plurality of protrusions includes the prisms, the protrusion layer has a plurality of peaks and a plurality of valleys, and the prisms wind along a longitudinal direction thereof.

18. An apparatus, comprising:
a light source; and
an optical sheet configured to receive light from the light source, the optical sheet comprising:
a base film, and
a protrusion layer including a plurality of protrusions and disposed over the base film,
wherein the base film includes a first layer over which the protrusion layer is disposed, a second layer over which the first layer is disposed, and the second layer is formed of the same material as that of the first layer, and the first layer and the second layer include a wavy surface where the first layer is disposed over the second layer.

19. The apparatus of claim 18, wherein the first layer has a first thickness T1 at one point on the base film and a second thickness T2 at another point on the base film, the first and second thicknesses T1 and T2 are different from each other, and the first and second thicknesses T1 and T2 satisfy the following equation: 0.1 μm≦|T1−T2|≦10 μm.

20. The apparatus of claim 18, wherein the second layer has a third thickness T3 at one point on the base film and a fourth thickness T4 at another point on the base film, the third and fourth thicknesses T3 and T4 are different from each other, and the third and fourth thicknesses T3 and T4 satisfy the following equation: 0.1 μm≦|T3−T4|≦10 μm.
